(19) United States
(12) Patent Application Publication
(10) Pub. No.: US 2003/0085127 A1
(43) Pub. Date: May 8, 2003

(54) Polymer additive useful in separation media

(75) Inventors: Didier Benoit, San Jose, CA (US); Nastaran Ghajari, Gilroy, CA (US); Hasan Ghajari, Gilroy, CA (US); Gerrit Klaerner, San Jose, CA (US)

Correspondence Address: SYMYX TECHNOLOGIES INC, LEGAL DEPARTMENT, 3100 CENTRAL EXPRESS, SANTA CLARA, CA, 95051

(73) Assignee: Symyx Technologies, Inc., Santa Clara, CA

(21) Appl. No.: 10/171,154

(22) Filed: Jun. 12, 2002

Related U.S. Application Data
(60) Provisional application No. 60/298,463, filed on Jun. 13, 2001.

(51) Int. Cl. G01N 27/26; G01N 27/447

(52) U.S. Cl. 204/469; 204/456; 204/606

(57) ABSTRACT

An additive poly(N,N-dimethylacrylamide) polymer having a molecular weight between about 115,000 and 750,000 and a polydispersity of greater than about 1.3 is useful in a capillary electrophoretic separation medium formulation for improving the separation performance of separation media, especially media that includes linear polyacrylamide.

### BACKGROUND OF THE INVENTION

The present invention relates generally to formulations having a polymer additive designed to improve the separation of biological molecules in capillary electrophoresis systems. The invention relates more specifically to a relatively narrow range molecular weight poly(N,N-dimethylacrylamide) polymer that improves separation resolution when used in a formulation for separation media.

Electrophoresis and/or electroosmotic flow is a technique used for separation and analysis of charged molecules such as biopolymers (e.g., nucleic acid polymers such as DNA, RNA and amino acid polymers such as proteins). Typically, one or more samples containing molecules to be separated or analyzed are loaded onto a separation media, and a voltage is applied across the media. The applied voltage causes the charged molecules to move differentially, thereby fractionating the sample into its various components.

In capillary gel electrophoresis, a voltage is generally applied across a capillary that comprises a separation media. The separation medium can be stationary or flowing relative to the capillary. Typically, stationary separation media comprises either a crosslinked gel, a polymer solution, or other flowable media. Samples such as biomolecules are loaded or otherwise disposed onto or into stationary or flowing separation media. The applied voltage causes the biomolecules to differentially migrate, relative to the separation media, to a detector. The rate at which the biomolecule migrates depends upon a number of factors including the nature of the biomolecule, the size and weight of the biomolecule, the charge on the biomolecule, the nature and properties of the separation media, and the conditions under which the separation is performed.

Capillary electrophoretic separation approaches have been automated, but such approaches have limitations with respect to sample component resolution. Known separation media for capillary gel electrophoresis typically comprise linear polymer chains that may become entangled and thereby impart a mesh-like characteristic to the separation media. The pore-size of such an entangled mesh is dynamic such that the size and persistence time of the mesh in a linear polymer is related to both the chain length and the number of chains per unit volume. Hence, both polymer molecular weight and polymer concentration will impact the separation capabilities of the media for different sample components (e.g., different lengths of DNA). Resolution of relatively smaller sample molecules is more effective with a more closely-knit mesh—requiring lower molecular weight chains and/or higher polymer concentrations, whereas higher molecular weights are preferred for larger molecules.

For example, U.S. Pat. Nos. 5,290,418 and 5,468,365 to Menchen et al. discuss various polymeric separation media, including block polymers of hydrophobic and hydrophilic segments. Low viscosity polymers are disclosed in U.S. Pat. No. 5,126,021 to Grossman. Sassi et al. disclose thermoreversible hydrogels in U.S. Pat. Nos. 5,631,337 and 5,883,211. Karger et al. have demonstrated the utility of linear polyacrylamide polymers for DNA sequencing, with the polyacrylamide typically being part of a formulation that, includes polymers of different molecular mass. See Karger et al., Anal. Chem., 1998, 70, 3996-4003; Anal. Chem., 1998, 70, 1516-1527; Electrophoresis, 1998, 19, 242-248; Anal. Chem., 2000, 72, 1045-1052; and Anal. Chem., 1996, 68,3305-3313.

To aid in separation, others have applied either a permanent coating (i.e., a static coating) to the capillary inner walls or a dynamic coating that temporarily coats the inner capillary walls. A dynamic coating, generally, comprises a component of the separation media that interacts with the capillary wall, effectively “coating” the wall. Also, since static coated capillaries are generally expensive, most commercial systems employ un-coated capillaries, and the separation media formulation includes a dynamic wall-coating component. Others have also provided a dynamic coating that comprises dimethylacrylamide polymer in separation media formulations, see, e.g., U.S. Pat. No. 5,567,292, which explains that coating the wall of un-coated capillaries reduces analyte-wall interactions. See also, U.S. Pat. Nos. 5,552,028, 6,074,542 and 5,948,227. However, poly(N,N-dimethylacrylamide) is also a polymer that is known for separation or sieving in a capillary electrophoresis medium. See, e.g., Chiari et al., J. Chromatography A, 781 (1997) 347-355.

Therefore, the teachings regarding poly(N,N-dimethylacrylamide) could be clearer and others have generally focused on broad disclosures. For example, U.S. Pat. No. 5,567,292 lists the molecular weight of the wall coating polymer as between 5,000 and 1,000,000 daltons. Also for example, U.S. Pat. No. 5,948,227 lists a range from between about 1,000 and 6,000,000 daltons for microchannel type separations. Ciari et al., Electrophoresis, 1998, 19, 3154-3159 disclose the use of a small amount of poly(N,N-dimethylacrylamide) as a dynamic wall coating agent, however, the reference never discloses the properties of the polymer used. It has now been surprisingly found that particular poly(N,N-dimethylacrylamide) polymer properties provide superior separation performance in a capillary electrophoresis systems having un-coated inner capillary walls.

This invention at least in part meets the need in the art for improved polymeric materials suitable for use in connection with capillary gel electrophoresis and improved polymer formulations.

### SUMMARY OF THE INVENTION

It is, therefore, an object of the invention to provide separation media having improved separation capabilities. It is further an object of this invention to provide an optimized additive polymer for use in a formulation used as separation media in capillary electrophoresis.

In one aspect, this invention comprises an additive polymer, which comprises or consists essentially of poly(N,N-dimethylacrylamide) having a weight average molecular weight of less than about 750,000 daltons and more preferably a weight average molecular weight of more than about 115,000 daltons. For a molecular weight between about 160,000 and 680,000 daltons, it has been observed that a polydispersity of greater than 1.3, preferably greater than 1.5 may be needed. By including from about 0.01 to about 0.5 wt % of this additive polymer in a formulation for capillary electrophoresis separation media, surprisingly, improved separation behavior has been observed.

In another aspect, a formulation for capillary clectrophoresis is provided that comprises the additive polymer, and optionally other known polymers for separations. In this aspect, it is has been found that using linear polyacrylamide, along with the polymers of this invention provides a particularly beneficial polymer formulation for capillary electrophoretic separations. These formulations have sufficiently low viscosity that they are replaceable and work well for short length, un-coated capillaries.

Improved separation abilities mainly are derived from a narrower peak width in a capillary electrophoresis experiment for the separation of different sized DNA. Narrower peak widths provide the possibility for increased resolution, which has also been observed.

Other features, objects, aspects and advantages of the present invention will be in part apparent to those skilled in art and in part pointed out hereinafter. All references cited in the instant specification are incorporated by reference for all purposes. Moreover, as the patent and non-patent literature relating to the subject matter disclosed and/or claimed herein is substantial, many relevant references are available to a skilled artisan that will provide further instruction with respect to such subject matter.

### BRIEF DESCRIPTION OF THE DRAWING

FIG. 1 is a graph of nucleotide fragment size as compared to peak width as a function of the molecular weight of the additive polymer poly(N,N-dimethylacrylamide) (PDMA), and using linear polyacrylamide as the separation polymer, where the molecular weight of the additive PDMA is narrowed to the range of from about 160,000 to about 680,000, and with a polydispersity of 1.5 or 1.6. FIG. 1 is based on data in Example 2.

FIG. 2 is a graph of nucleotide fragment size as compared to peak width as a function of the molecular weight of the additive polymer poly(N,N-dimethylacrylamide) (PDMA), and using linear polyacrylamide as the separation polymer, where the molecular weights of 1,700,000 and 680,000 are compared for peak width. FIG. 2 is based on data in Example 3.

### DETAILED DESCRIPTION

According to the present invention, a small amount poly(N,N-dimethylacrylamide) provides enhanced performance for separation systems, and especially for electrophoretic separation systems such as capillary gel electrophoresis. Separation media comprising such polymers as well as other polymers can be tailored for a particular separation objective of interest. While the polymers are advantageously applied for use in separation media as detailed herein, other applications are also contemplated (e.g., rheology control, thermosets).

This invention has surprisingly found that a certain molecular weight and polydispersity poly(N,N-dimethylacrylamide) provides superior separation performance when used in a capillary electrophoresis separation media formulation. Improved performance in the context of capillary electrophoresis separation of biological samples generally can be one of many different properties, including narrower peak width. See, generally, Heller et al., Electrophoresis, 1998, 19, 3114-3127, which is incorporated herein by reference. In particular, when used with linear polyacrylamide (LPA), poly(N,N-dimethylacrylamide) having weight average molecular weight of between about 115,000 and about 750,000 daltons is preferred, and more preferably between about 160,000 and about 680,000 daltons. The poly(N,N-dimethylacrylamide) is prepared as is known in the industry, as briefly discussed below.

Another important factor is the polydispersity index of the polymer. It has been observed that the ability to provide superior performance to replaceable separation media, the poly(N,N-dimethylacrylamide) should have a polydispersity index (PDI) (i.e., weight average molecular weight over number average molecular weight) above about 1.3. In preferred embodiments, the polydispersity index is preferably not less than about 1.4 or about 1.5 or about 1.6. For some molecular weight poly(N,N-dimethylacrylamide) it has been observed that a polydispersity of less than about 1.3 (e.g., 1.2) is adverse to separation performance and thus, such lower polydispersities are outside the scope of this invention.

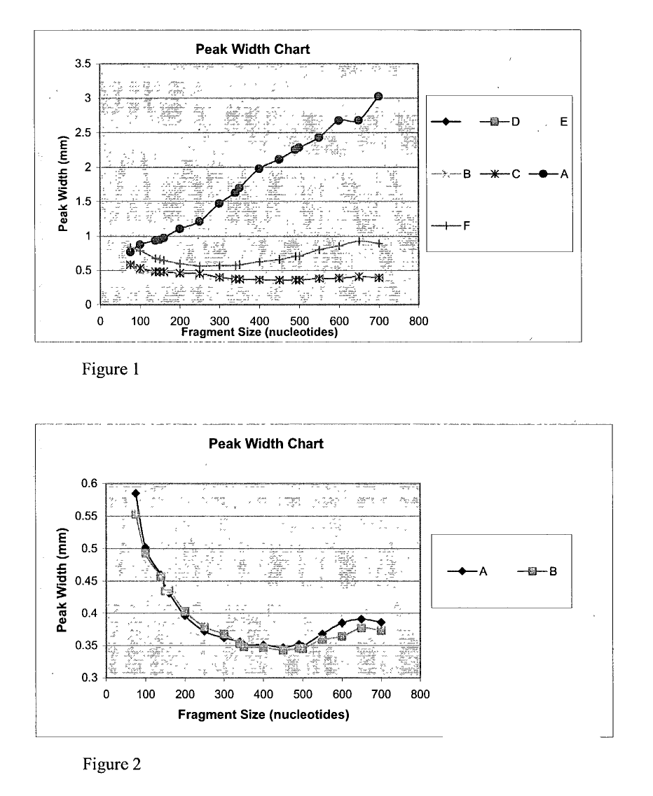

This range of molecular weight for poly(N,N-dimethylacrylamide) with PDI provide superior performance with respect to a narrowed peak width for DNA separation. The advantage of narrow peaks is that at similar peak intervals, narrower peak widths for higher DNA fragments can increase the crossover point, which essentially increases the read length of the sequences. In this context, the crossover point is the point where the peak interval curve crosses with the peak width curve, which, in other words simulates the ability to call a one base sequence difference with an accuracy of greater than 98.5%. Narrower peak widths are generally preferred in capillary electrophoresis because they allow for more peaks (i.e., base pairs) to be resolved in an equal amount of time as compared to wider peak widths. More specifically, as shown in FIG. 1, a lower molecular weight poly(N,N-dimethylacrylamide) of about 50,000 daltons provides wider peaks while a higher molecular weight poly(N,N-dimethylacrylamide) of about 1,200,000 daltons also provides a wider peak width. A narrower separation peak width was observed with the addition of 0.2% w/w of poly(N,N-dimethylacrylamide) (PDMA) to a separation media of linear polyacrylamide, where the PDMA had a molecular weight of about 160,000 dalton and about 680,000 daltons. The data is logically extendable to the range of about 115,000 daltons to about 750,000 daltons, given the variability in testing for molecular weight and polydispersity (which was performed here using rapid size exclusion chromatography as disclosed in). FIG. 2 shows a comparison of additive 0.2 wt. % PDMA at a molecular weight of 1,700,000 as compared to 680,000 mixed with a 2.5 wt. % sieving linear polyacrylamide. FIG. 2 in enlarged as compared to FIG. 1, but nonetheless shows that PMDA of molecular weight 1,700,000 and polydispersity of about 2.2 still provided wider peak widths than the polymer additives of this invention. The narrower peak widths correspond to improved performance of approximately an additional 20 base pairs separated in an equal amount of time as compared to other formulations.

Molecular weight and polydispersity are determined as known in the art. A preferred method is described in commonly assigned U.S. patent application Ser. No. 09/285,363, filed Apr. 2, 1999, which is herein incorporated by reference. Generally, a solvent, such as N,N-dimethylformamide (optionally containing about 0.1% of trifluoroacetic acid) is used as an eluent in polystyrene-based columns and molecular weight results are obtained relative to linear polystyrene standards.

The additive PDMA should be miscible in the other polymers, solvent, and other components of the complete separation medium used for the capillary electrophoresis system. The PDMA is preferably water-soluble or water dispersible. More specifically, the soluble polymers are at least partially water soluble, and are preferably substantially water-soluble or completely water soluble. As used herein, the term “at least partially soluble” means that at least some amount of the compound of interest is present as a solute in a continuous phase solution medium. The dispersible polymers are preferably uniformly dispersed mixtures of solid polymer particles in a liquid, preferably aqueous, continuous phase. The polymers are preferably water soluble or water dispersible as described, but can, less stringently, be soluble (at least partially soluble) or dispersible (preferably uniformly dispersible) in the aqueous-medium of the separation medium (as defined below). Capillary gel electrophoresis medium that are aqueous solutions or aqueous dispersions are preferred over non-aqueous separation medium, because they provide the necessary environment for electrophoresis (e.g. ions) and provide good solubility for most biomolecules of interest. Aqueous solutions also provide for ease of handling, low toxicity and cost-savings as compared to organic solvents. The viscosity of the PDMA is not critical in the general case, but can be important in some applications—particularly in applications in which flow of the polymer is desired or required. Hence, the viscosity of the PDMA should, in general, be suitable for use in the particular application at hand (e.g., capillary gel electrophoresis).

Separation Media

The formulation of separation media is well known in the art, see for example, U.S. Pat. No. 5,264,101, incorporated herein by reference. The polymers of the invention can be used to form a separation medium for fractional separation of samples having more than one component. When applied in connection with capillary gel electrophoresis, for example, such separation media facilitates the separation and/or analysis of a variety of biomolecules including proteins, polysaccharides and polynucleotides (i.e., nucleic acid oligomers and polymers), among others. Separation media formed from including the additive polymer of this invention are particularly useful for fractionating nucleic acid polymers such as deoxyribonucleic acid (DNA) polymers. Although much of the discussion and examples presented herein for the separation media are directed to capillary gel electrophoresis, use in such applications is to be considered as exemplary and non-limiting, except as required in the claims. The separation medium typically comprises at least one polymer and the additive polymer of the invention in an aqueous medium.

The particular polymer (or blend of polymers) to be employed in the separation media can be selected to achieve particular desired properties of the separation medium (e.g., viscosity) as well as particularly desired capabilities (performance characteristics) of the separation media. For example, the polymer(s) of the separation media can be selected (e.g., tailored) to achieve a particular resolution, throughput or peak capacity for a particular sample or sample fraction (e.g., a polynucleotide having a specific number of base pairs). In most embodiments the polymers or blend of polymers chosen for the separation medium are miscible with each other.

The aqueous medium of the separation formulation comprises water, and preferably at least about 50% water by weight relative to total weight of the aqueous medium. The weight-percentage of water in the aqueous medium can generally range from about 50% water to about 100% water. Water can be combined with water-miscible liquids, such as methanol or other alcohols. The aqueous medium can also be a buffer or an electrolyte solution. Aqueous buffer solutions having a pH range suitable for the sample molecules of interest. For DNA separation, for example, pH can range from about 6 to about 9. For protein separation, the pH can vary over a larger range, depending on the particular protein of interest. Some proteins and other biopolymers can require relatively extreme pH conditions for separation.

The separation medium can be prepared by combining one or more polymers with the aqueous medium, and mixing to form an aqueous solution or an uniformly dispersed aqueous dispersion. The polymer loading in the separation media formulation is not narrowly critical, but can be important in some cases—with respect to performance criteria (e.g., sample resolution, throughput and/or peak capacity) and/or properties of interest (e.g., viscosity, solubility, dispersibility and/or flowability). For applications directed to capillary gel electrophoresis, the polymer loading should be sufficient to provide adequate resolution for the sample fraction of interest, without adversely affecting flowability and/or other desirable properties of the separation media.

Significantly, polymer loading, in combination with other properties, especially molecular weight and viscosity of the separation medium, can be an effective control parameter for performance features (e.g., flowability, sample throughput, etc.). For capillary gel electrophoresis, for example, the high-end loading limit may be functionally constrained by viscosity, solubility and/or more generally, flowability. In general, for such applications, the separation media comprises polymer at a loading of at least about 1% and more preferably at least about 2%, in each case the percentage being by total weight of polymeric components relative to total weight of the separation media. In some embodiments, the polymer loading may range as high as at least about 50% by total weight of polymeric components relative to total weight of the separation media. Hence, the separation media can generally comprise polymer(s) at a loading ranging from about 1% to about 50%, and preferably from about 2% to about 20%, in each case the percentage being by total weight of polymeric components relative to total weight of the separation media. In some embodiments, relative low polymer loading are preferred, including for example, polymer loadings ranging from about 1% to about 10%, and preferably from about 1% to about 3%, in each case by total weight of polymeric components relative to total weight of the separation media.

The viscosity of the separation medium is preferably suitable for the application of interest, and in preferred embodiments, suitable for capillary gel electrophoresis. In particular, the viscosity of the separation medium should be controlled or adjusted such that the separation media is a flowable medium at the analysis temperature—typically about 50° C., and in some cases preferably up to about 60° C. or higher for capillary gel electrophoresis. As used herein, the term “flowable medium” means generally, a medium which can flow under a motive force (e.g., pressure head developed by a pump) through a capillary with an internal diameter or width of the system in which it will be used—typically of not more than about 100 μm. Other parameters, such as the temperature at which the separation/analysis of sample molecules is effected, polymer loading, and degree of solubility could each, independently and cumulatively, also have an effect on viscosity and/or flowability at a given polymer loading. The viscosity and, independently and cumulatively, the flowability of the separation medium are preferably suitable for capillary gel electrophoresis in a system comprising a capillary having an interior diameter or width of about 100 μm or less, preferably of about 75 μm or less, more preferably of about 50 μm or less, still more preferably of about 25 um or less, even more preferably of about 10 μm or less, and most preferably of about 5 μm or less. As such, the viscosity of the separation medium is suitable for microelectrophoretic applications. Characterized with respect to other aspects of particular importance with respect to automation, for example, the viscosity is suitable for filling, flushing and refilling the separation medium from such capillaries (e.g., for stationary separation-medium systems) and/or for flowing within the capillary (e.g., for flow or counter-flow systems) at the molecular weights and polymer loadings of interest.

Preferred embodiments of the separation media are discussed as follows. With respect to these preferred separation media, it is to be understood that the aforementioned details relating to a particular property or feature of the polymer, or of the separation media apply as well to the property or feature as generally referred to below—without further mentioning of every such detail each time that reference is made to such property or feature.

Therefore, one separation media comprises one or more additive poly(N,N-dimethylacrylamide) polymer(s) (as described above) having a weight average molecular weight of between about 115,000 daltons and about 750,000 daltons, in a concentration of from about 0.01% to about 0.5% w/w and is at least partially soluble in water or aqueous medium, or dispersible in water or aqueous medium. This preferred embodiment is especially useful with linear polydimethylacrylamide or combinations of different polymers with linear polydimethylacrylamides. Other known separation polymers can be used, such as those described in U.S. Pat. Nos. 5,264,101, 5,948,227, 5,567,292 and 5,885,432, each of which is incorporated herein by reference.

Separation media for capillary gel electrophoresis may comprise a blend of polymers. Such separation media comprise at least two different polymers and an aqueous medium. As used herein, the term “different polymers” means that the polymers differ with respect to composition, chain length, architecture, crystallinity, hydrodynamic volume or some other property related to a bulk sample of the polymer as formed. Hence, two linear polymers having the same repeat units can be different polymers if they have different average chain lengths. Two linear polymers having identical chain lengths, but different repeat units, or different arrangement of repeat units are also considered to be different polymers. Moreover, in these embodiments, the contemplated scope of the repeat units for the polymers is broader—in that such media can consist essentially of polymeric components that do not include polymers having acrylamide-based repeat units. Preferably, however, one or more of the polymers will include acrylamide-based repeat units.

Therefore, in one embodiment with a blend of polymers, the separation media for capillary gel electrophoresis can include a first polymer and second polymer. The first and the second polymer are different polymers, but each are at least partially soluble in water or aqueous medium, or dispersible in water or aqueous medium. In this embodiment the first polymer is a separation copolymer (as is known in the art), the second polymer is a linear polyacrylamide. The first polymer may be present in the range of from about 15 wt. % to about 50 wt %. The second polymer may be present in the range of from about 50 wt % to about 85 wt %. This embodiment may includes an additive polymer of this invention in the range of from about 0.01% to about 0.5% w/w. Each of such polymers are combined with (e.g., solubilized or dispersed in) an aqueous medium to form a solution or dispersion with a viscosity suitable for capillary gel electrophoresis. Thus a formulation of this embodiment may be:

1-10% w/w polymer

90-99% w/w aqueous solution,

with the above polymer component comprising one or more separation or sieving polymers and about 0.01-0.5 wt % of the additive PDMA polymer of this invention. The aqueous solution, above, includes other components that are commonly employed for different applications. Other components may include buffering agents or solutions, denaturing agents, urea and the like. See, e.g., U.S. Pat. Nos. 5,885,432, incorporated herein by reference.

Capillary Gel Electrophoresis

Capillary gel electrophoresis systems are commercially available from a variety of manufacturers including, e.g., Applied Biosystems, Beckman, and Molecular Dynamics. Capillary gel electrophoresis instruments generally include a capillary capable of being connected at opposite ends to opposing polarity terminals of a voltage source, a detector, a sampling mechanism, and a separation medium disposed within the capillary. The geometry of the capillary is not critical. Typically, the capillary can be a tube (e.g., a silica tube) and/or a channel (e.g., formed in the surface of a substrate). See the aforementioned US patents for particular systems.

The capillaries of the present invention can have an inner diameter or width ranging from about 5 μm to about 200 um, preferably ranging from about 5 μm to about 100 μm, and more preferably ranging from about 10 μm to about 75 μm. Such capillaries can be closed or open capillaries, and can have a cylindrical-shaped interior geometry or a non-cylindrical interior geometry (e.g., oval, square, triangular, parallelogram). Such geometries may be dictated (or even preferred), for example, due to the fabrication techniques (e.g., etch angles associated with microfabrication). Hence, more generally, the capillaries can have a hydraulic radius (i.e., cross-sectional area divided by circumference (or partial circumference for open channels) ranging from about 0.25 μm to about 50 um, preferably ranging from about 0.25 μm to about 25 μm, and more preferably ranging from about 2 μm to about 20 μm. The length of the capillary can range from about 1 cm to about 100 cm, and preferably from about 10 cm to about 100 cm. In more preferred embodiments, the capillary length is about 30-60 cm. The capillaries are often made of fused silica. Flow of the separation medium can be restricted by, e.g., the use of a frit or constricted plug, which prevents the flow of the separation medium out of the tube.

According to one aspect of the present invention, even relatively small-diameter or width capillaries—e.g., having an interior diameter or width of not more than about 75 μm (and preferably less, with incrementally smaller diameter or widths/hydraulic radius as described above) can be filled, flushed and refilled. Hence, the capillary gel electrophoresis system can comprise a fill port for providing separation medium to one or more capillaries, a flushing port for removing spent medium therefrom, a motive force source (e.g., pump) for effecting movement of the separation media into and/or out of the capillary, and optionally, and preferably, a process control system for controlling such operations. Such a process control system can include a computer, software providing a control logic, and one or more control elements (e.g., valves, pump speed controller, etc).

In operation, the separation medium is pumped into the tube so as to fill the tube with the separation medium. Volumetric flowrates for filling the tube are controlled by the pump speed to range, generally, from about 50 μl/min to about 100 μl/min. The separation medium should fill the tube substantially uniformly and homogeneously, such that voids or discontinuities that would interfere with the sample analysis are minimized, and preferably substantially nonexistent. Typically, the medium is stationary (not flowing) during the analysis. In some applications, however, flow—in the same direction as sample-molecule migration or counter-current thereto—can be maintained through the capillary throughout the analysis. The sample(s) to be analyzed can be placed into the separation media prior to loading such media into the capillary, or alternatively, such sample(s) can be applied to an exposed surface of the separation media or applied to a subsurface volume of the separation media after the separation medium has been established into the capillary, for example, by electro-kinetic injection. An electric field is applied across the capillary. The sample, now subjected to the electric field, migrates through the separation medium to the detector, with different sample components migrating at different relative speeds through the separation medium. The detector provides an output signal, typically versus a time domain. The output signal is typically generated, for DNA sample fractions, by detecting tags incorporated into the particular nucleotides (A, C, T and/or G). The output signal can be correlated to the signal obtained from samples comprising standards of known fractions. For example, for analysis of DNA samples, DNA ladders with fractions having a known number and sequence of base pairs can be used for the correlation.

The capillaries of the aforementioned capillary gel electrophoresis systems preferably comprise one of the separation medium described above, alone, or in combination with other separation media.

Preparation of Polymers

The polymers of this invention, as variously characterized above, can be prepared by several different approaches. In general, those of skill in the art will appreciate that the polymerization processes may be living-type or not, with a non-living system being preferred. The preparation of the polymers of this invention is generally known in the art. In the context of this application the additive polymers are prepared under polymerization conditions, which are the conditions needed for polymerization to occur.

A polymerization reaction mixture of this invention uses those components that are needed for the particular mechanism being practiced. For the preferred embodiment of an uncontrolled polymerization, the polymerization reaction includes at least initiator and monomer. A reaction mixture comprising the free-radical intiator and monomer can be formed in a number of different ways. The free-radical initiator can be provided as such to the reaction mixture, or can be formed in situ under initiation conditions or under polymerization reaction conditions from a free-radical initiator precursor.

The initiators employed in the present invention can be a commercially available free-radical initiator. The initiators are preferably water-soluble initiators and/or monomer-soluble initiators, but can also include non-aqueous solvent-soluble intitators. More specifically, suitable free radical initiators include any thermal, redox or photo initiators, including, for example, alkyl peroxides, substituted alkyl peroxides, aryl peroxides, substituted aryl peroxides, acyl peroxides, alkyl hydroperoxides, substituted alkyl hydroperoxides, aryl hydroperoxides, substituted aryl hydroperoxides, heteroalkyl peroxides, substituted heteroalkyl peroxides, heteroalkyl hydroperoxides, substituted heteroalkyl hydroperoxides, heteroaryl peroxides, substituted heteroaryl peroxides, heteroaryl hydroperoxides, substituted heteroaryl hydroperoxides, alkyl peresters, substituted alkyl peresters, aryl peresters, substituted aryl peresters, azo compounds and halide compounds. Specific initiators include cumene hydroperoxide (CHP), t-butyl hydroperoxide (TBHP), t-butyl perbenzoate (TBPB), sodium carbonateperoxide, benzoyl peroxide (BPO), lauroyl peroxide (LPO), methylethylketone peroxide 45%, potasium persulfate, ammonium persulfate, 2,2-azobis(2,4-dimethyl-valeronitrile) (VAZO®-65), 1,1-azobis(cyclo-hexanecarbonitrile) (VAZO®-40), 2,2-azobis(N,N′-dimethyleneisobutyramidine) dihydrochloride (VAZO®-044), 2,2-azobis(2-amidinopropane) dihydrochloride (VAZO®-50) and 2,2-azobis(2-amido-propane) dihydrochloride. Redox pairs such as persulfate/sulfite and Fe(2+)/peroxide are also useful. As noted above, and as used herein, the initiator may be added to the polymerization mixture independently or may be incorporated into another molecule, such as a monomer (discussed below for hyper branching) or a polymer or polymer fragment (for grafting, etc.). Initiation may also be by heat or UV light, as is known in the art, depending on the embodiment being practiced. Those of skill in the art can select a proper initiator within the scope of this invention, but the most preferred initiator for the separation copolymers is a redox pair comprising ammonium persulfate and N,N,N′N′-tetramethylethylenediamine (TEMED).

A reaction mixture comprising the monomer(s), the free-radical initiator (or precursor thereof) and other components is formed and is subjected to polymerization conditions. A chain transfer agent is typically used to control the molecular weight. Typical examples of chain transfer agents can be found in G. Moad and D. H. Solomon, The Chemistry of Free Radical Polymerization (Pergamon, 1995), and in particular pages 234-259, which is incorporated herein by reference. Preferably, water soluble and/or miscible alcohols are used as the chain transfer agent, with the alcohols possibly acting as a solvent also. The polydispersity is generally increased through the use of a chain transfer agent and by selecting an appropriate initiator, which is within the skill of one of ordinary skill in the art. Control of the polymerization reaction for preparing the polymers of the invention is provided by controlling various combinations of the following: ratio of monomer concentration to chain transfer concentration; selection of initiator; the ratio of monomer to initiator; and polymerization reaction conditions. These ratios can vary depending upon the desired molecular weight, initiator efficiency and conversion. For example, the ratio of monomer concentration to chain transfer concentration can vary from about 10:1 to about 1:10, depending on the chain transfer agent. Example 1, below, demonstrates molecular weight control with isoproponal. Also for example, the monomer to initiator ratio can range from about 10:1 to about 1,000,000:1 and more preferably from about 100:1 to about 10,000:1, by mole, assuming an initiator efficiency of about 1 and about 100% conversion.

Polymerization reaction conditions to be controlled include temperature, pressure, reaction time, and head-space atmosphere, among others. The temperature can generally range from about 0° C. to about 300° C., preferably from about 0° C. to about 200° C., and more preferably from about 20° C. to about 150° C. A room temperature reaction is most preferred. The reaction pressure can vary from atmospheric pressure to about 100 atmospheres, and preferably from about atmospheric pressure to about 10 atm. The atmosphere of the reaction-vessel head-space, above the polymerization mixture, can air, nitrogen, argon or another suitable atmosphere, with an inert atmosphere being preferred. The polymerization reaction time can range from about 0.1 hours to about 72 hours, preferably from about 0.5 hours to about 36 hours, and more preferably from about 1 hour to about 24 hours. The solvent for the polymerization is preferable water, with additional solvents being added as needed, such as an alcohol (e.g., isopropanol) as a chain transfer agent. Other solvents known to those of skill in the art can be used, such as dimethylformamide, DIGLYME or other polar solvents. The polymerization can also be in bulk. The polymerization reaction conditions can be established, in general, prior to or after the reaction components are combined.

A number of different workup procedures can be used to purify the polymer of interest. Briefly, such approaches include: (i) precipitation, and fractionating reprecipitation of the polymers; (ii) membrane separation (e.g., aqueous dialysis) of the polymers; and/or (iii) freeze-drying of the polymers.

In some contexts, a living type process may be employed, and those of skill in the art can chose between the known different living type polymerization processes to find a process that best fits a particular application. Such techniques include nitroxide mediated, radical addition fragmentation transfer (RAFT or MADIX), iniferter and atom transfer radical polymerization (ATRP).

### EXAMPLES

Chemicals were generally purchased from commercial sources and used as received, except as indicated below and monomers, which were filtered through a short column of basic aluminum oxide to remove any inhibitor and degassed by applying vacuum. All polymerization mixtures were prepared in a glove box under a nitrogen or argon atmosphere and sealed. Size Exclusion Chromatography was performed using automated rapid GPC system, as described above. In the current setup N,N-dimethylformamide containing 0.1% of trifluoroacetic acid was used as an eluent and polystyrene-based columns. All of the molecular weight results obtained are relative to linear polystyrene standards.

### Example 1

Fourteen polymerization experiments were carried out under inert atmosphere, with 0.4 ml of degassed N,N-dimethyl acrylamide introduced in the selected mixture of solvents and chain transfer agents as set forth below (A to N).

TABLE 1

| Mixture | A | B | C | D | E | F | G |
|---|---|---|---|---|---|---|---|
| Isopropanol (ul) | 0 | 70 | 180 | 354 | 1770 | 2655 | 3540 |
| Water (ul) | 3540 | 3470 | 3360 | 3186 | 1770 | 886 | 0 |
| Mw (g/mol) | — | 680,000 | 500,000 | 320,000 | 85,000 | 57,000 | 48,000 |

| Mixture | H | I | J | K | L | M | N |
|---|---|---|---|---|---|---|---|
| Isopropanol (ul) | 0 | 35 | 90 | 177 | 885 | 1327 | 1770 |
| Water (ul) | 1770 | 1735 | 1680 | 1593 | 885 | 443 | 0 |
| Mw (g/mol) | 1,200,000 | 600,000 | 460,000 | 160,000 | 98,000 | 87,000 | — |

To each vial are introduced successively 100 ul of an aqueous solution of N,N,N′,N′ tetramethyl ethylenediamine (TEMED) (10 mg/ml) followed by 100 ul of an aqueous solution (10 mg/ml) of ammonium persulfate. The polymerization occurs right away and is allowed to proceed overnight. The solutions are kept under stirring on an orbital shaker. At the end, water is added to ensure a complete dissolution of the viscous mixture. Each sample is then freeze-dried and lyophilized for 2-3 days. The resulting powder is analyzed by GPC (7 min. method) in dimethylformamide (DMF), and the observed molecular weights are listed in the above table 1 (A-N).

### Example 2

DNA separations were performed on an Applied Biosystems, Inc. (ABI) 310 capillary electrophoresis machine with polymer gels containing the same separation polymer (linear polyacrylamide) (LPA) and different additive polymer (poly(N,N-dimethylacrylamide) (PDMA) with different Mw). LPA can be prepared as is known in the art (see the above cited references), but in this example was obtained from ABI and analyzed for molecular weight and PDI prior to use. PDMA was prepared following the general protocol of Example 1, above.

A 2% w/w polymer solution of linear polyacrylamide (M_{W} 2.3 M from light scattering analysis) with 0.2% w/w of PDMA was prepared with ABI 3700 Running Buffer with EDTA and 7.14 M urea. A 47 cm×50 μm ABI capillary with the effective length of 36 cm to the detection window was used for each separation media sample. The module used for this experiment has the following conditions: 400 seconds capillary filling with 1 ml syringe, 5 min capillary conditioning at 9.4 KV, 0.5 KV injection voltage, 10 seconds injection time, 60 seconds post injection run followed by 9.4 KV running voltage and 60 minutes running time. Data was collected with frequency of 4 hz. ABI 3700 Running Buffer with EDTA was used as a running buffer. DNA separation was performed on the 18 fragments DNA having the following lengths 75, 100, 139, 150, 160, 200, 250, 300, 340, 350, 400, 450, 490, 500, 550, 600, 650, and 700 base pairs. Four injections were performed for each separation media sample at 50° C. Electropherogram was analyzed with software to estimate the crossover point.

Table 2 provides average crossover point and migration time for the
2% LPA + 0.2% PDMA at 50° C.

| Sample # | M_{w} of PDMA | PDI | Crossover pt | Migration time |
|---|---|---|---|---|
| A | 50,000 | 1.5 | 128 ± 10 | 46 ± 1 |
| B | 160,000 | 1.5 | 650 ± 8 | 46 ± 1 |
| C | 320,000 | 1.6 | 637 ± 4 | 44 ± 1 |
| D | 500,000 | 1.6 | 642 ± 3 | 43 ± 1 |
| E | 680,000 | 1.6 | 657 ± 5 | 42 ± 1 |
| F | 1,200,000 | 1.4 | 368 ± 17 | 59 ± 5 |

FIG. 1 is a graph of the peak width data obtained from Example 2, showing samples A-F.

### Example 3

DNA separations were performed on an Applied Biosystems, Inc. (ABI) 310 capillary electrophoresis machine with polymer gels containing the same separation polymer (linear polyacrylamide) (LPA) and different additive polymer (poly(N,N-dimethylacrylamide) (PDMA) with different Mw). LPA can be prepared as is known in the art (see the above cited references), but in this example was obtained from ABI and estimated to be of a molecular weight of approximately 2,500,000 based on the viscosity of the sample received. A 13% aqueous solution of PMDA (sample A, below) was received from ABI and the PDMA isolated and tested to be of molecular weight and PDI, as shown below in Table 3. PDMA (sample B, below) was prepared following the general protocol of Example 1, above.

A 2.5% w/w polymer solution of LPA with 0.2% w/w of PDMA was prepared with ABI 3700 Running Buffer with EDTA and 7.14 M urea. A 47 cm×50 μm ABI capillary with the effective length of 36 cm to the detection window was used for each separation media sample. The module used for this experiment has the following conditions: 400 seconds capillary filling with 1 ml syringe, 5 min capillary conditioning at 9.4 KV, 0.5 KV injection voltage, 10 seconds injection time, 60 seconds post injection run followed by 9.4 KV running voltage and 60 minutes running time. Data was collected with frequency of 4 hz. ABI 3700 Running Buffer with EDTA was used as a running buffer. DNA separation was performed on the 18 fragments DNA having the following lengths 75, 100, 139, 150, 160, 200, 250, 300, 340, 350, 400, 450, 490, 500, 550, 600, 650, and 700 base pairs. Four injections were performed for each separation media sample at 50° C. Electropherogram was analyzed with software to estimate the crossover point.

Table 3 provides average crossover point and migration time for the
2.5% LPA + 0.2% PDMA at 50° C.

| Sample # | M_{w} of PDMA | PDI | Crossover pt | Migration time |
|---|---|---|---|---|
| A | 1,700,000 | 2.2 | 670 ± 5 | 55 ± 1 |
| B | 680,000 | 1.6 | 685 ± 5 | 52 ± 1 |

FIG. 2 is a graph of the peak width data obtained from Example 3, showing samples A and B.

In light of the detailed description of the invention and the examples presented above, it can be appreciated that the several objects of the invention are achieved. The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention.

All references, patents, articles, etc. cited herein are incorporated herein by reference for all purposes.

What is claimed is:

1. A separation medium for capillary electrophoresis, comprising:
about 0.01 to about 0.5% w/w of linear poly(N,N-dimethylacrylamide) having a molecular weight between about 1 15,000 and about 750,000 daltons and a polydispersity of greater than 1.3, which is at least partially water soluble;
at least one other polymer in sufficient quantity to cause sieving of a biological molecule,
and an aqueous solution,
with said medium having a viscosity of less than about 1000 centipoise.

2. The separation medium of claim 1, wherein said molecular weight is between about 160,000 and about 6800,000 daltons and said polydispersity is greater than or equal to 1.4.

3. The separation medium of claim 1, wherein said separation polymer is a linear polyacrylamide.

4. A capillary filled with an electrophoresis separation medium comprising:
about 0.01 to about 0.5% w/w of linear poly(N,N-dimethylacrylamide) having a molecular weight between about 115,000 and about 750,000 daltons and a polydispersity of greater than 1.3, which is water soluble;
at least one other polymer that functions as a separation polymer, and said medium having a viscosity of less than about 1000 centipoise.

5. The capillary tube of claim 4, wherein said molecular weight is between about 160,000 and about 6800,000 daltons and said polydispersity is greater than or equal to about 1.4.

6. The capillary tube of claim 5, wherein said separation polymer is a linear polyacrylamide.

7. A method of separating a mixture of biological molecules within an electrophoretic separation medium comprising:
placing into a capillary a composition comprising at least about 0.01 to about 0.5% w/w of linear poly(N,N-dimethylacrylamide) having a molecular weight between about 115,000 and about 750,000 daltons and a polydispersity of greater than 1.3, which is water soluble; at least one other polymer that functions as a sieving polymer, and said composition having a viscosity of less than about 1000 centipoise;
adding a mixture of biological molecules to the electrophoretic separation medium at one end of the capillary; and
applying an electric field to the medium in an amount sufficient to facilitate the migration and separation of the biological molecules.

8. The method according to claim 7, wherein said molecular weight is between about 160,000 and about 680,000 daltons and said polydispersity is greater than or equal to about 1.4.

9. The method according to claim 8, wherein said separation polymer is a linear polyacrylamide.
